(19) United States
(12) Patent Application Publication
(10) Pub. No.: US 2025/0198899 A1
(43) Pub. Date: Jun. 19, 2025

(54) DEVICES, SYSTEMS, AND METHODS FOR MITIGATION OF RISK DUE TO EXPOSURE TO PARTICULATE MATTER

(71) Applicant: L'Oreal, Paris (FR)

(72) Inventors: Ritesh SINHA, Linden, NJ (US); Xuefei LIU, Edison, NJ (US); Hy Si BUI, Piscataway, NJ (US)

(73) Assignee: L'Oreal, Paris (FR)

(21) Appl. No.: 18/543,504

(22) Filed: Dec. 18, 2023

(51) Int. Cl. G01N 15/06; G01N 15/075; G06Q 30/0601; G06V 10/56; G06V 10/74

(52) U.S. Cl. CPC G01N 15/0606; G01N 15/075; G06V 10/56; G06V 10/74; G06Q 30/0631

(57) ABSTRACT

Devices, systems, and methods for determining and measuring exposure to environmental particulate matter. A pollution detection article implements a polymer that becomes darkened or discolored as a result of adherence of airborne particulate matter to the polymer, as well as a discoloration reference. A computational device includes hardware and processor circuitry configured to capture an image of the pollution detection article, compute a degree of discoloration of the polymer, and compute the level of exposure of the pollution detection article to environmental particulate matter based on the degree of discoloration of the polymer. The pollution detection article can be used as a standalone article to monitor exposure or can be incorporated into other articles, products, devices, or environments for low-maintenance and computational device-facilitated monitoring of environmental particulate matter exposure.

### SUMMARY

In an aspect, the disclosure provides a computational device configured for determination of exposure to airborne particulate matter, the computational device comprising: circuitry configured to capture an image of a pollution detection article, wherein the image includes imagery of a discoloration reference of the pollution detection article and imagery of a polymer of the pollution detection article, wherein the polymer is configured to adsorb airborne particulates thereon to cause the polymer to become a discolored polymer; and circuitry configured to compare the discoloration reference to the discolored polymer for an optical comparison, wherein the optical comparison enables determination of whether the pollution detection article has airborne particulate matter exposure.

In embodiments, the discoloration reference optically corresponds to the discolored polymer, such that the imagery of the discoloration reference at least partially matches the imagery of the discolored polymer for determination of whether the pollution detection article has airborne particulate matter exposure. In embodiments, the computational device further comprises circuitry configured to determine whether the pollution detection article has airborne particulate matter exposure based on the optical comparison.

In embodiments, the pollution detection article comprises a plurality of discoloration references along a gradient and each discoloration reference corresponds to a degree of discoloration of the discolored polymer.

In embodiments, the computational device further comprises circuitry configured to determine a level of airborne particulate matter exposure of the pollution detection article based on the optical comparison.

In embodiments, the computational device further comprises circuitry configured to display, via a user interface, a recommendation for an action and/or a product based on a level of airborne particulate matter exposure of the pollution detection article as determined based on the optical comparison.

In embodiments, circuitry of the computational device is configured for image recognition detection of the discoloration reference and the discolored polymer based on an arrangement of the pollution detection article.

In embodiments, the arrangement includes a position of the discoloration reference relative to a position of the discolored polymer, or is predefined based on a layout of the discoloration reference and the discolored polymer on the pollution detection article.

In embodiments, the discoloration reference comprises an aperture thereon, such that a portion of a surface positioned underneath the aperture appears adjacent to the discoloration reference for the optical comparison between the discoloration reference and the discolored polymer.

In an aspect, the disclosure provides a computational device configured for measurement of exposure to airborne particulate matter, the computational device comprising: circuitry configured to capture an image of a pollution detection article, wherein the image includes imagery of a plurality of discoloration references along a gradient and imagery of a polymer of the pollution detection article, wherein the polymer is configured to adsorb airborne particulates thereon to cause the polymer to become a discolored polymer; and circuitry configured to compare the plurality of discoloration references to the discolored polymer for an optical comparison, wherein the optical comparison enables measurement of exposure of the pollution detection article to airborne particulate matter.

In embodiments, each discoloration reference corresponds to a level of exposure to airborne particulate matter that is based at least in part on an airborne concentration of particulate matter in an environment.

In embodiments, the optical comparison comprises: computing, based on imagery of the image, a degree of discoloration of the discolored polymer; and computing a degree of discoloration of the plurality of discoloration references that is associated with the degree of discoloration of the discolored polymer to enable measurement of exposure of the pollution detection article to airborne particulate matter.

In embodiments, the optical comparison comprises: computing, based on imagery of the image, a plurality of degrees of discoloration of the plurality of discoloration references and computing a standard curve thereof configured for the computing the degree of discoloration of the plurality of discoloration references.

In embodiments, the computation device further comprises circuitry configured to display, via a user interface, a recommendation for an action and/or a product based on a level of airborne particulate matter exposure of the pollution detection article as determined based on the optical comparison.

In embodiments, the recommendation is further based on a historical level of airborne particulate matter exposure of the pollution detection article and/or a historical level of airborne particulate matter exposure of an individual.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

FIG. 1 shows an exploded perspective view of an example pollution detection patch, according to the disclosure.

FIG. 2 shows a top view of the example pollution detection patch, unexposed to particulate pollution.

FIG. 3 shows a top view of the example pollution detection patch, after being exposed to a degree of particulate pollution such that a polymer of the patch is discolored.

FIG. 4 shows a top view of the example pollution detection patch, after being exposed to particulate pollution, with a discoloration reference configured for an optical comparison rotated for comparison with the discolored polymer.

FIG. 5 shows a flowchart of steps of an example method for mitigating risk due to exposure to particulate matter using an example pollution detection patch and a computational device according to the disclosure.

FIG. 6 shows a flowchart of steps of an example method for computing an exposure level and generating a recommendation for mitigating risk due to exposure to particulate matter, as can be performed with a computational device according to the disclosure. FIG. 7A shows a first example user interface of a computational device according to the disclosure, highlighting risk of a skin breakout or acne event.

FIG. 7B shows a second example user interface of a computational device according to the disclosure, highlighting risk of a skin breakout or acne event.

FIG. 7C shows a third example user interface of a computational device according to the disclosure, highlighting trends or activities related to exposure events.

FIG. 7D shows a fourth example user interface of a computational device according to the disclosure, highlighting historical trends in the environment, lifestyle, and weather and exposure forecast.

FIG. 7E shows a fifth example user interface of a computational device according to the disclosure, highlighting a value of an exposure metric related to UV, pollution, and relative humidity.

FIG. 7F shows a sixth example user interface of a computational device according to the disclosure, highlighting pollution and humidity levels across several days.

FIG. 7G shows a seventh example user interface of a computational device according to the disclosure, highlighting compatibility of a product with an individual's pollution and exposure levels as they relate to the individual's goals for reducing exposure to pollution and harmful UV light.

FIG. 7H shows an eighth example user interface of a computational device according to the disclosure, highlighting an example product for reducing an individual's exposure to pollution and harmful UV light.

FIG. 7I shows a ninth example user interface of a computational device according to the disclosure, highlighting an individual's resilience to exposure to pollution and harmful UV light, and recommending an example action to the individual.

FIG. 7J shows a tenth example user interface of a computational device according to the disclosure, highlighting an example action using an example product to the individual, with the aim of reducing exposure to pollution and harmful UV light.

FIG. 7K shows an eleventh example user interface of a computational device according to the disclosure, highlighting an example action using an example product, UV protection level, and pollen level to the individual, with the aim of reducing exposure to pollution and harmful UV light.

The foregoing aspects and many of the attendant advantages of this disclosure will become more readily appreciated as the same become better understood by reference to the following detailed description, when taken in conjunction with the accompanying drawings.

### DETAILED DESCRIPTION

Particulate pollution or particulate matter (PM) is comprised of particles of solids and/or liquids that are in the air. Examples include dust, dirt, soot, smoke, and drops of liquid. This type of pollution can come from primary sources that form particles on their own, such as wood stoves and forest fires, as well as secondary sources that emit gases that in turn form particles, such as power plants, coal fires, factories, vehicles, and the like. Oftentimes, these emissions contain PM as fine particles (e.g., PM2.5) and/or coarse particles (e.g., PM10). Fine particles (e.g., PM2.5) can be considered particularly dangerous to health since they can penetrate the skin, lungs, blood, and/or other organs and cause health problems. In particular, exposure to PM2.5 has been associated with ischemic heart disease, stroke, COPD, diabetes mellitus, and lung cancer (Sang, S. et al. The global burden of disease attributable to ambient fine particulate matter in 204 countries and territories, 1990-2019: A systematic analysis of the Global Burden of Disease Study 2019. Ecotoxicol Environ Saf. 2022 Jun. 15; 238:113588.). There is a need for devices, systems, and methods for monitoring PM that can be reliably implemented in a consumer or industrial setting for PM exposure monitoring over longer timelines. The present disclosure meets these and other long-felt and unmet needs in the art.

### Pollution Detection Patches

In an aspect, the disclosure provides an article, e.g., a pollution detection patch, for determination of exposure to airborne particulate matter. In embodiments, the article can be operable for monitoring exposure to airborne particulate matter in combination with a computational device of the disclosure. The article can comprise a polymer, e.g., a hydrophobic polymer, that adsorbs airborne particulates thereon, causing a discoloration in the polymer as a result of the adsorption of the particulate matter to the polymer. The article can further comprise a discoloration reference that contains one or more reference values for optically comparing, with a computational device or system, degree of discoloration of the polymer with the reference. This optical comparison enables determination of whether the article has airborne particulate matter exposure, and if so, to what degree, via a computational device or system.

In embodiments, the article is for a binary determination, with a computational device or system of the disclosure, of whether or not the article is exposed to PM in an environment (i.e., PM exposure TRUE or FALSE). However, in embodiments, the article can be discolored according to a degree of discoloration, and a plurality of discoloration references, e.g., along a gradient, is configured for an optical comparison with the discolored polymer with a computational device or system. In such embodiments, the optical comparison of the computational device or system correlates a particular discoloration reference of the gradient with the degree of discoloration of the discolored polymer for measurement of exposure of the article to airborne particulate matter with a computational device or system.

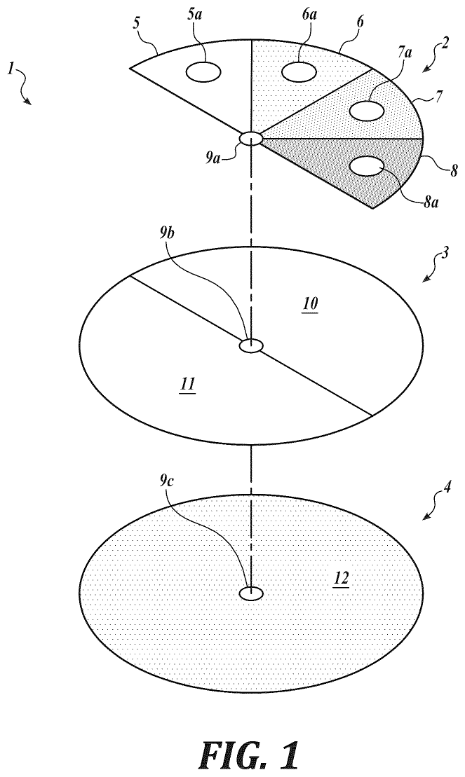

By way of example, at FIG. 1, there is shown an example pollution detection patch, according to the disclosure, in exploded perspective view. In the shown embodiment, a pollution detection patch 1 comprises a plurality of discoloration references 2 (i.e., comprised of individual discoloration references 5, 6, 7, 8) along a gradient, such that each discoloration reference corresponds to a degree of discoloration of the discolored polymer. For example, reference 5 corresponds to zero or negligible PM exposure; reference 6 corresponds to light exposure; reference 7 corresponds to intermediate exposure; and reference 8 corresponds to heavy exposure. The shade of the reference increases in opacity or darkness with higher corresponding levels of exposure. In the shown embodiment, article 1 is circular, and the arrangement of the plurality of discoloration references 2 is a semi-circle, and each discoloration reference (5, 6, 7, 8) is a circle sector of the semi-circle. However, other article shapes and other arrangements of the plurality of discoloration references 2 can be implemented, according to embodiments. In embodiments, the plurality of discoloration references 2 can be laminated with a transparent polymer film or glass, for example.

In the shown embodiment, the plurality of discoloration references 2 is disposed on a semi-circular piece of suitable material, such as a fabric, a paper, a polymer, a plastic, a wood, a metal, or any combination thereof, or another suitable material; however, other shapes and/or materials can be implemented, in embodiments. In the shown embodiment, the plurality of discoloration references 2 is arranged such that references are adjacent to each other in an arrangement with the gradient increasing along the arrangement, however, the references (5, 6, 7, 8) can be arranged in any arrangement. In the shown embodiment, each reference (5, 6, 7, 8) contains an aperture (5a, 6a, 7a, 8a) therethrough, such that surfaces positioned underneath the aperture are visible when viewed from above the article, as explained elsewhere herein. In this manner, the references (5, 6, 7, 8) are more easily visually or optically compared with the polymer for determination of an exposure level by a computational device or system.

In the shown embodiment, patch 1 comprises a polymer layer 3, comprised of an inert support 10 and a polymer 11; in embodiments, inert support 10 is coated with a dispersion of a pollutant attractive polymer, as described elsewhere herein. The inert support 10 can be non-reactive with PM, however, the polymer 11 is reactive with PM in the sense that it adsorbs PM thereto, resulting in discoloration of the polymer 11 and functionality of the patch in detecting and/or quantitating airborne PM exposure levels in the environment. In embodiments, polymer 11 is deposited to a half of a circular disk-shaped inert support 10, such that half the inert support 10 does not comprise the polymer thereon, and the other half of the inert support 11 does comprise the polymer thereon. However, in embodiments, more of the inert support 10, e.g., the entire inert support 10, can receive polymer 11 deposited thereto for full coverage of the upper surface of the polymer layer 3 with polymer 11.

In the shown embodiment, article 1 further comprises an attachment portion 4 configured for attachment of the article 1 to a surface. Attachment portion 4 can comprise, for example, an adhesive tape, a magnetic layer for attachment of the patch to metal surfaces such as cars or otherwise, a hook-and-loop attachment, or another structure on a bottom of attachment portion 4. Attachment portion 4 can include an adhesive 12 on a top of attachment portion 4 for securement of the polymer layer 3 thereto.

In embodiments, attachment portion 4 can be configured for hanging article 1 to a surface or other article, or a body of an individual who wears article 1. In instances where an individual wears article 1, article 1 can function as a kind of “dosimeter” for monitoring of the individual's exposure to PM. This wearable “exposome monitor” can monitor individual exposure and serve as an early warning system for potentially harmful exposure levels, enabling the individual to mitigate their exposure to potentially harmful pollution (e.g., “exposome”) by adjusting their location, behavior, or routine, or implementing other protective actions such as applying protective materials, substances, or personal protective equipment (PPE) for protection of the individual from potential health problems due to exposure to PM. In example embodiments, the patch can be used as an indicator for when and/or where respiratory masks and/or eye or other protection should be worn, for example. In embodiments, the patch itself can be used as an indicator as to when and/or where a filter, such as a respiratory mask or other PM filter, becomes worn or clogged and should be maintained, cleaned, or replaced; for example, patch 1 can be attached to or integral with a respiratory mask, such as an N95 respiratory mask, or the like. In addition, in industrial settings, for example, accumulation of airborne PM can be an indicator of an actual or potential equipment failure; in such instances, patch 1 can be used to warn operators of a pending failure or a need for equipment maintenance.

In the shown embodiment, a central hinge is comprised of an upper pin 9a, that extends through polymer pinhole 9b and attachment portion pinhole 9c for securement of the plurality of discoloration references 2 with the polymer layer 3 and the attachment portion 4 to form an assembled state of the article 1 for use. Central hinge (91, 9b, 9c) enables rotation of the plurality of discoloration references 2 relative to the polymer layer 3, as described elsewhere herein, for easier visual comparison of the references (5, 6, 7, 8) with the discoloration of polymer 11.

In embodiments, references of the plurality of discoloration references (5, 6, 7, 8) correspond to qualitative levels of exposure to PM as computed and/or communicated by a computational device or system. For example, it can suffice in at least some situations that the level of PM exposure is indicated by the computational device or system as “light”, “intermediate”, or “heavy”, as the case may be. However, in other situations, references of the plurality of discoloration references 2 (i.e., 5, 6, 7, 8) correspond to defined, quantitative levels of exposure to PM. An example of a defined level of exposure can include exposure to a particular airborne concentration of PM, optionally for a particular period of time. In embodiments, references of the plurality of discoloration references can be selected or calibrated based on performance of a particular polymer across a range of defined, quantitative levels of exposure to PM. In this manner, the coloration or shade of a given discolored polymer state can be matched with a particular reference for determination of an at least approximate exposure level as indicated by that reference. For example, suppose that reference 6 corresponds to a PM exposure quantitation of X. If the polymer of the article becomes discolored such that it at least approximately resembles reference 6, then it can be stated that a PM exposure quantitation in one or more environments within which the article is placed is at least approximately X. In this manner, the article can be configured for qualitative use and/or quantitative use, and can be used in any of a variety of scenarios, including personal use, industrial use, and others.

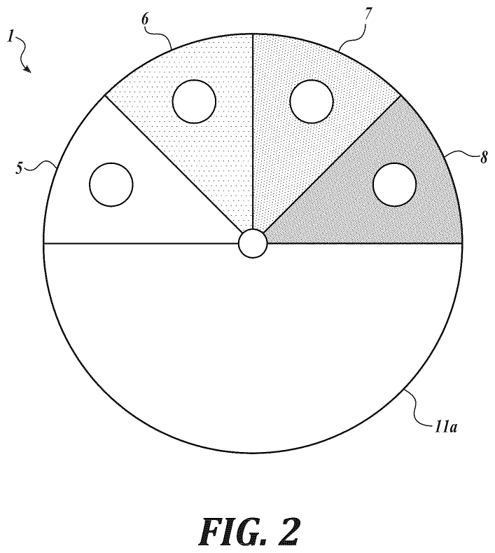

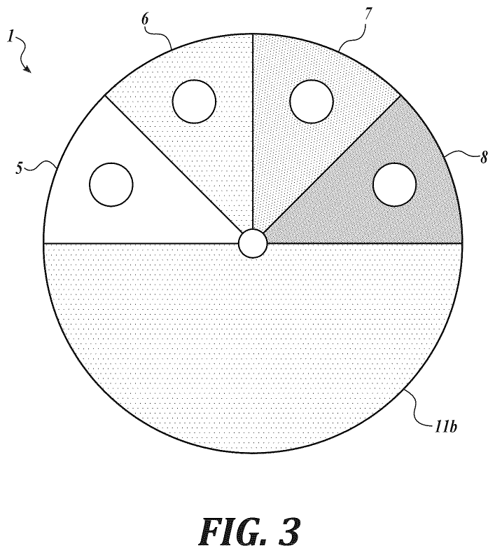

Referring now to FIG. 2, there is shown a top view of the example pollution detection patch 1, in an assembled state and unexposed to particulate pollution. The polymer is in a non-discolored state 11a, and optically corresponds to reference 5, i.e., negative control reference. In the shown embodiment, the non-discolored state 11a of the polymer is bright white. As shown at FIG. 3, after being exposed to a degree of particulate pollution such that a polymer of the patch is discolored, the polymer is in a discolored state 11b. In the shown embodiment, discolored state 11b optically corresponds to reference 6, such that a visual appearance of the discoloration reference 6 at least partially matches a visual appearance of the discolored polymer 11b for determination of whether the article has airborne particulate matter exposure, and if so, to what degree.

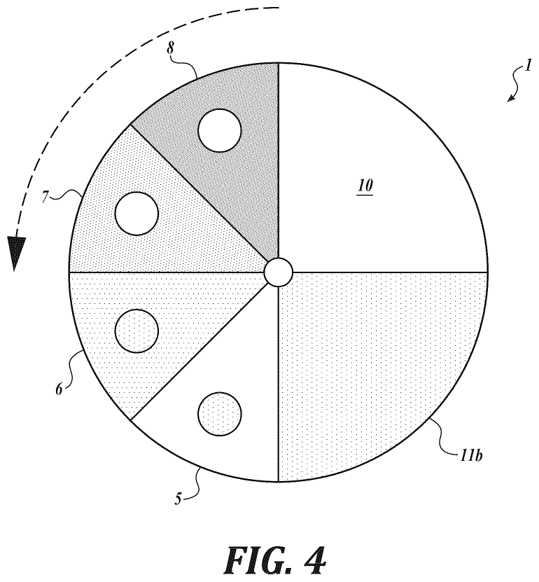

Referring now to FIG. 4, there is shown a top view of the example pollution detection patch 1, after being exposed to particulate pollution, with a discoloration reference 6 configured for an optical comparison moved or rotated for comparison with the discolored polymer 11b by a computational device or system. In the shown embodiment, the plurality of discoloration references (5, 6, 7, 8) are rotated 90 degrees such that discoloration reference 6 overlaps with the polymer as the polymer is in the discolored state 11b. In this configuration, the discolored state 11b is visible through the aperture of reference 6, for easier visual comparison of reference 6 with the discolored state 11b. In the shown example, discolored state 11b at least approximately corresponds with reference 6, e.g., based on a grayscale coloration and/or hue, brightness, chromaticity, and/or saturation, for example. The discolored state 11b, and other discolored states of the polymer, can appear as decreases in brightness of the default bright white coloration, for example. The determined exposure can be graduated, for example, as a score from 1 to 10, wherein 1 is lesser exposure and 10 is greater exposure to PM, according to embodiments.

In embodiments, the pollution detection patch can be implemented as, or incorporated into, any form factor according to need. Example form factors include a disposable patch, a reusable patch, a washable patch, a wrist band, a finger ring, a neck ring, or another wearable form factor. In embodiments, the patch can be attached to a vehicle, a house or other structure, equipment monitoring systems, manufacturing or machining systems, and the like.

In embodiments, the polymer used for making the patch is hydrophobic and can attract airborne pollution such as dust, carbon soot, PM2.5, and others. In example embodiments, a polymer produced by MYCELX® can be used as a polymer of a patch or article of the disclosure, however, any suitable polymer or other material can be used according to its effectiveness. Example MYCELX® polymer compositions for making a polymer of a patch or article of the disclosure can include, by way of non-limiting examples, one or more compositions or polymers disclosed in U.S. Pat. No. 5,746,925, one or more compositions or polymers disclosed in U.S. Pat. No. 5,437,793, and/or one or more compositions or polymers disclosed in U.S. Pat. No. 5,698,139, each of which is incorporated by reference herein in its entirety for all purposes.

In embodiments, a polymer composition of the disclosure can be produced by chemically reacting (e.g., crosslinking) linseed oil with isobutyl methacrylate, and the product diluted with a suitable solvent, such as 2,2,4-trimethyl-1,3-pentanediol monoisobutyrate. The composition formed by the thermal reaction of the linseed oil with the isobutyl methacrylate polymer is a soft resinous product which, when diluted with the solvent, results in a mixture that can be sprayed onto a surface, such as inert support 10 of the patch of the disclosure. In embodiments, a polymer of the article of the disclosure can be produced from methacrylate polymers and any of a variety of natural animal and vegetable oils. The oil and the polymer can be reacted in a thermal reaction that does not appear to be sensitive to the atmosphere under which the reaction is carried out, i.e., whether it is an inert, oxidizing or reducing atmosphere. Compositions that have an oil to polymer ratio ranging from about 3:1 to 1:1 can be used, resulting in polymers exhibiting physical properties ranging from soft to hard, and elastomeric to brittle in nature depending upon the ratio of the oil to polymer and the choice of polymer and/or oil used.

In embodiments, a polymer composition can be applied to inert support 10 by reducing the viscosity of the polymer composition and depositing it onto inert support 10, which can be porous, in embodiments. Since the viscosity of MYCELX® polymer compositions at room temperature is very high (e.g., around 700-800 pa*s), in embodiments, a deposition method for depositing a polymer composition onto inert support 10 includes reducing viscosity of a polymer composition by heating, or dissolving in a solution, then depositing the reduced viscosity polymer composition on inert support 10.

As a first example of deposition of a polymer composition onto inert support 10, a first step includes mixing the polymer composition in caprylic/capric triglyceride at any concentration, from 0-100% to produce a polymer composition mixture; a second step includes submerging the patch (e.g., inert support 10, which can comprise cellulose, for example) in the polymer composition mixture for 30 minutes; and a third step includes removing the inert support 10 from the polymer composition mixture and drying the inert support 10, optionally at an elevated temperature, for a period (e.g., overnight).

As a second example of deposition of a polymer composition onto inert support 10, a first step includes mixing the polymer composition in isododecane at any concentration, from 0-100%, preferably 20-100%, to produce a polymer composition mixture; a second step includes submerging the patch (e.g., inert support 10, which can comprise cellulose, for example) in the polymer composition mixture for 30 minutes; and a third step includes removing the inert support 10 from the polymer composition mixture and drying the inert support 10, optionally at an elevated temperature, for a period (e.g., overnight).

### Kits and Methods

In other aspects, the disclosure provides kits that comprise one or more patches of the disclosure. Example embodiments of kits include a pollution detection patch, optionally in combination with instructional materials, for example. The kits can be provided and/or used as standalone units, or can be combined with other products or kits for combination offerings. An example combination kit includes one or more pollution detection patches and one or more skincare products, for example, for mitigation of adverse skin healthcare conditions that could result due to exposure to PM pollution, for example.

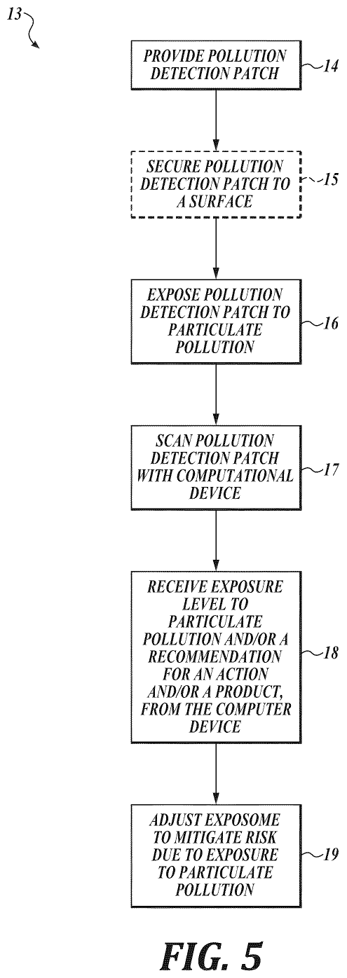

In other aspects, the disclosure provides methods for managing or mitigating risk due to exposure to PM, optionally in combination with one or more other pollutants or environmental stressors. As shown at FIG. 5, an example method 13 for mitigating risk due to exposure to particulate matter can use an example pollution detection patch according to the disclosure. In the shown embodiment, method 13 for mitigating risk comprises step 14: provide pollution detection patch, wherein a patch is provided to a person, group of people, or an organization. At step 15, which can be optional, the pollution detection patch can be secured to a surface. At step 16, the pollution detection patch is exposed to particulate pollution, resulting in discoloration of the polymer of the patch, as described elsewhere herein. At step 17, a computational device or system is used, e.g., by an individual operator for example, to scan the pollution detection patch, and the device or system computes PM exposure level of the patch based on device- or system-mediated optical comparison of imagery of one or more discoloration references with imagery of the discolored polymer. At step 18, the individual receives exposure level to particulate pollution and/or recommendation(s) for action(s) and/or product(s), from the computational device or system. At step 19, the person makes a change to adjust their exposome—the range of potentially harmful environmental exposures to which a person or group of individuals is exposed (including PM exposure)-such that the person or group of individuals has a lower risk of adverse health conditions due to their exposome. Example adjustments can include altering a route of travel or transport, staying indoors for a period of time, wearing a respiratory mask, applying a cosmetic composition to the skin or other body part, taking medication, or another action.

### Computational Devices, Systems, and Methods

In various aspects, the disclosure provides a computational device configured for determination of exposure to airborne particulate matter. The computational device comprises circuitry configured to capture an image of a pollution detection article (e.g., pollution detection patch 1 of FIGS. 1-4). The image of the patch includes imagery of a discoloration reference and imagery of a polymer configured to adsorb airborne particulates thereon to cause the polymer to become a discolored polymer, as described herein. The computational device further includes circuitry configured to compare the discoloration reference to the discolored polymer for an optical comparison, which enables determination, e.g., by the computational device, whether the pollution detection article has airborne particulate matter exposure. As such, in embodiments, the computational device further comprises circuitry configured to determine whether the pollution detection article has airborne particulate matter exposure based on the optical comparison (i.e., a binary determination; YES or NO). In embodiments, the computational device further comprises circuitry configured to determine a level of airborne particulate matter exposure of the pollution detection article based on the optical comparison (i.e., a measurement determination; level of exposure).

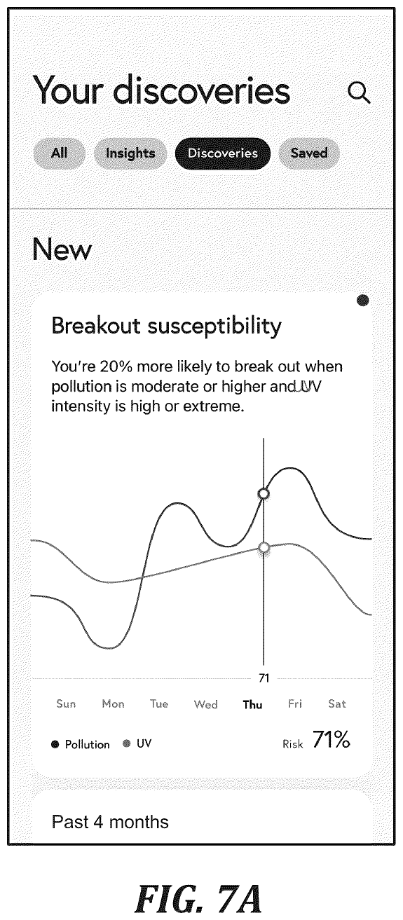

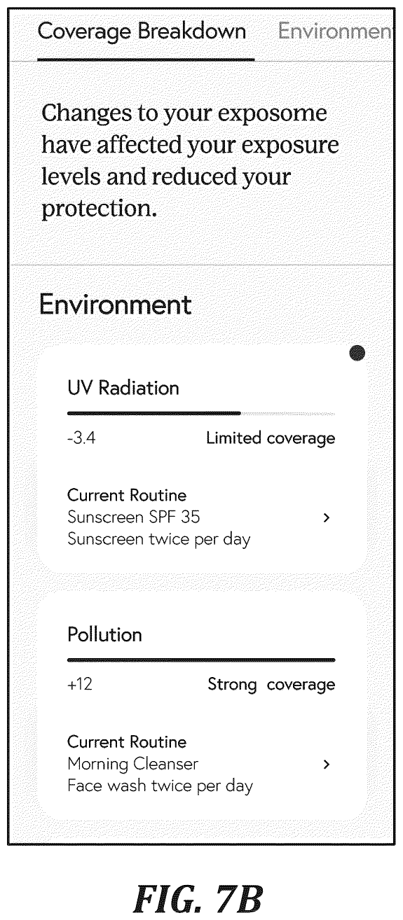

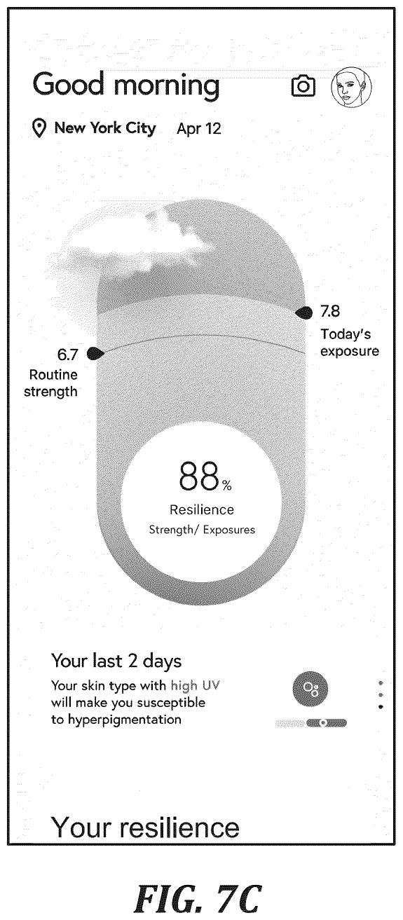

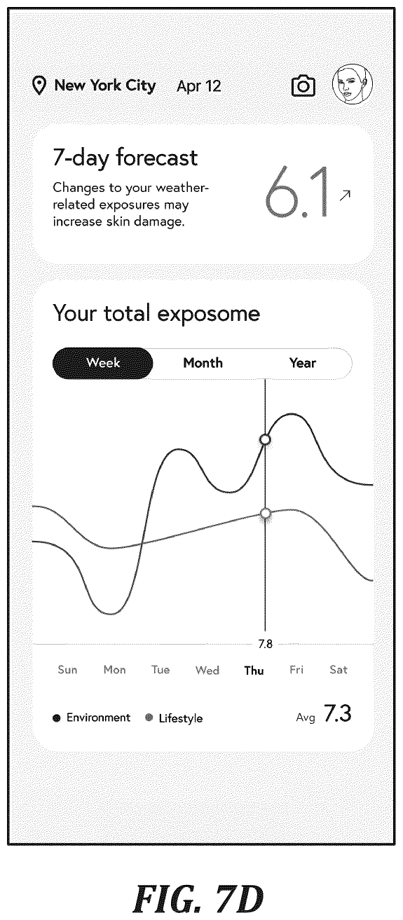

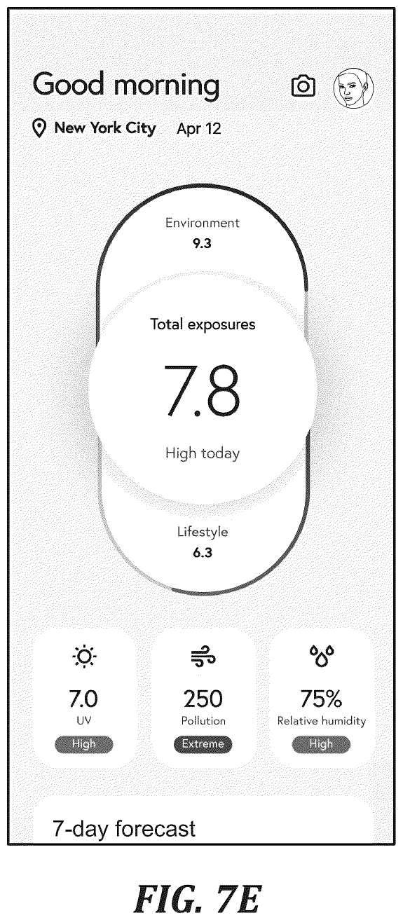

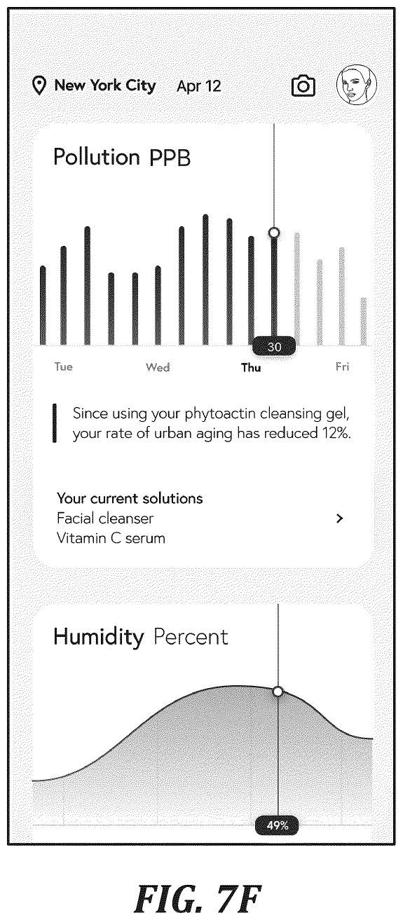

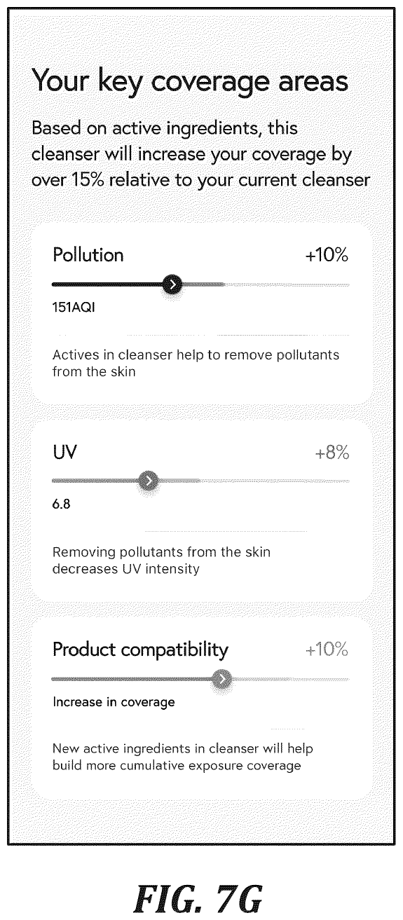

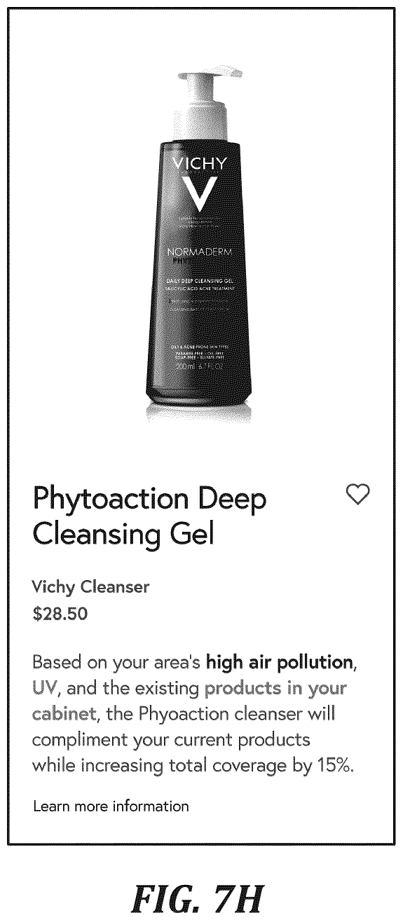

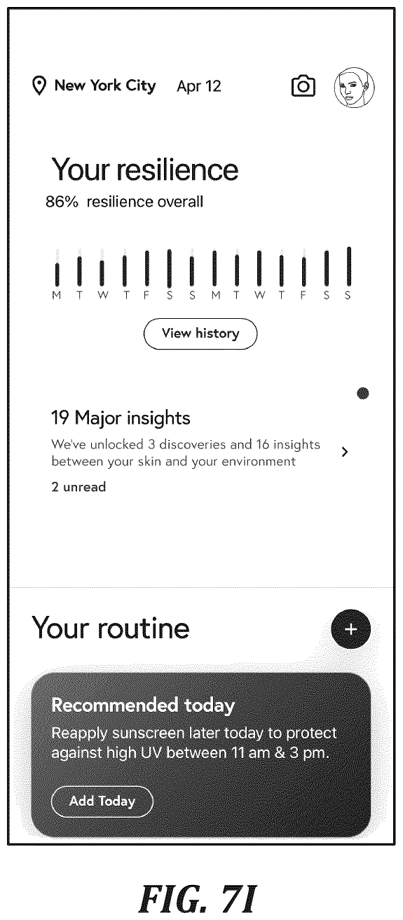

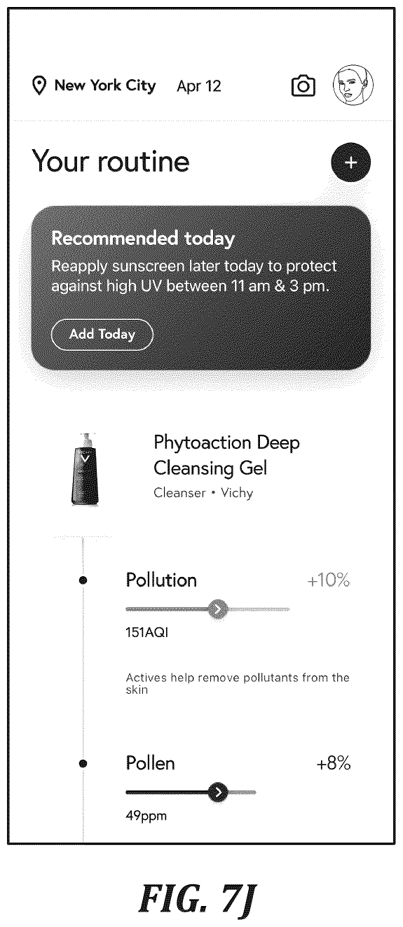

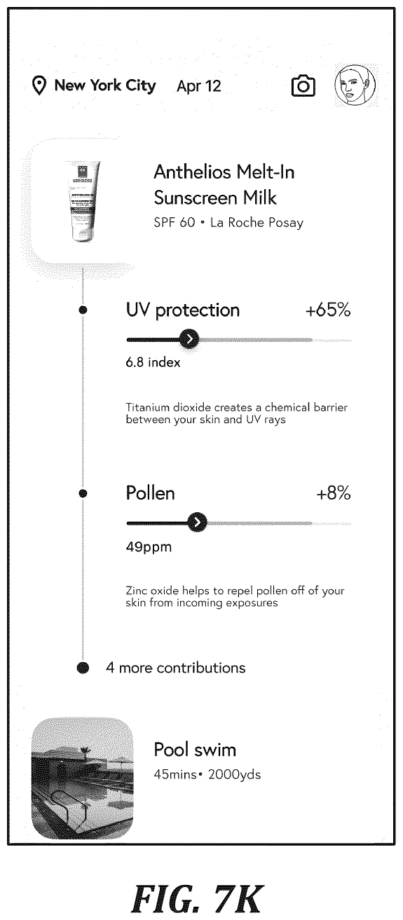

Non-limiting examples of user interfaces are shown at FIGS. 7A-7K. In embodiments, the computational device further comprises circuitry configured to display, via a user interface of the computational device, healthcare insights or discoveries, historical exposome trends, statistical information related to an exposome, environmental factors such as UV radiation, pollution, humidity, pollen levels, skincare routine(s) in use or suggested to be in use, lifestyle plans or trends such as exercise patterns or diet or sleep patterns, weather or forecast information, predicted future exposome information as a result of environment and lifestyle factors, qualitative or quantitative exposure information, perceived or computed or actual rate of aging, resilience trends, or the like, or any combination thereof. In embodiments, the computational device further comprises circuitry configured to display, via a user interface of the computational device, a recommendation for an action and/or a product based on a level of airborne particulate matter exposure of the pollution detection article as determined based on the optical comparison.

In embodiments, circuitry of the computational device is configured for image recognition detection of the discoloration reference and the discolored polymer based on an arrangement of the pollution detection article, which can be, for example, a (known or expected) position of the discoloration reference relative to a position of the discolored polymer, or can be predefined based on a layout of the discoloration reference and the discolored polymer on the pollution detection article, for example. In at least some embodiments, circuitry of the computational device is configured for image recognition detection of the discoloration reference and the discolored polymer independent of arrangement of the pollution detection article.

In various aspects, the disclosure provides a computational device configured for measurement of exposure to airborne particulate matter. The computational device comprises circuitry configured to capture an image of a pollution detection article. The image includes imagery of a plurality of discoloration references along a gradient and imagery of a polymer of the pollution detection article. The polymer is configured to adsorb airborne particulates thereon to cause the polymer to become a discolored polymer, as described herein. Circuitry of the computational device is configured to compare the plurality of discoloration references to the discolored polymer for an optical comparison, which enables measurement of exposure of the pollution detection article to airborne particulate matter. In embodiments, each discoloration reference corresponds to a level of exposure to airborne particulate matter that is based at least in part on an airborne concentration of particulate matter in an environment.

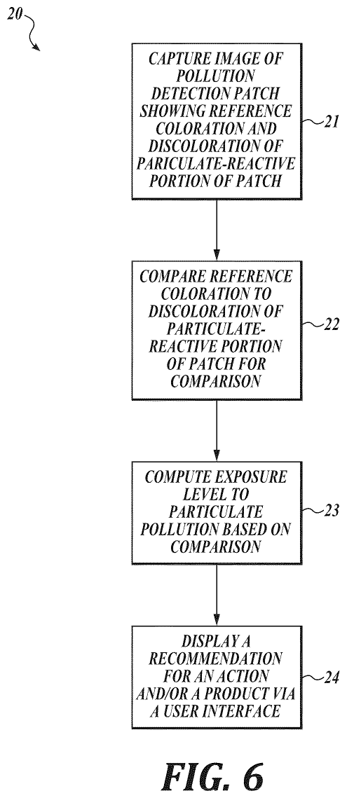

As shown at FIG. 6, an example method for computing an exposure level and generating a recommendation for mitigating risk due to exposure to particulate matter, as can be performed with a computational device according to the disclosure, is shown. The method 20 comprises, at step 21, capturing an image a pollution detection patch that shows reference coloration and polymer discoloration; at step 22, comparing reference coloration to discoloration of the polymer for an optical comparison; at step 23, computing exposure level to particulate pollution based on the optical comparison; and at step 24, displaying a recommendation for an action and/or a product via a user interface of the computational device. In embodiments, the optical comparison comprises computing, based on imagery of the image, a degree of discoloration of the discolored polymer, and computing a degree of discoloration of the plurality of discoloration references that is associated with the degree of discoloration of the discolored polymer. These computations enable measurement of exposure of the pollution detection article to airborne particulate matter, e.g., by the computational device. In embodiments, the optical comparison comprises computing, based on imagery of the image, a plurality of degrees of discoloration of the plurality of discoloration references and computing a standard curve thereof configured for the computing the degree of discoloration of the plurality of discoloration references, e.g., by the computational device.

In embodiments, the computational device comprises circuitry configured to display, via a user interface, a recommendation for an action and/or a product based on a level of airborne particulate matter exposure of the pollution detection article as determined based on the optical comparison, as described herein. In embodiments, the recommendation is further based on a historical level of airborne particulate matter exposure of the pollution detection article and/or a historical level of airborne particulate matter exposure of an individual, for example.

In embodiments, circuitry of computational device is configurable with a processor and processor-executable instructions stored on a non-transitory machine-readable medium of computational device, as a non-limiting example, but other approaches for configuring circuitry of computational device can be implemented in embodiments. In embodiments, computational device includes a processor for execution of instructions stored on a non-transitory machine-readable medium, for enabling the processor to carry out all or part of a method or process of the disclosure. Accordingly, in embodiments, a computational device includes a software application configured to perform all or part of one or more methods or processes of the disclosure, in any order or combination. In example embodiments, the computational device is a smartphone or other consumer computational device.

In embodiments, the computational device includes a camera or other optical sensor comprising hardware and corresponding logic and/or software for capturing one or more images of a pollution detection patch, analyzing the one or more images to produce an optical comparison, and computing exposure level of the pollution detection patch based on the optical comparison, as described herein. Further configuration of circuitry of the computational device can include networking circuitry, for example, circuitry configured for a wireless connection, such as a Bluetooth® connection, a Bluetooth® low energy (BLE) connection, and/or a Wi-Fi® connection, and/or a wired connection. The networking circuitry, in combination with circuitry of the computational device, can be used to request, retrieve, and/or receive data from a remote server, for example, historical and/or current data related to one or more individuals' exposomes, weather, pollen, pollution, UV radiation, and the like. The computational device can include circuitry for transmitting computed PM exposure levels to the remote server, for example, to update a data set related to one or more individuals' exposomes, weather, pollen, pollution, UV radiation, and the like.

### Non-Limiting Embodiments

While general features of the disclosure are described and shown and particular features of the disclosure are set forth in the claims, the following non-limiting embodiments relate to features, and combinations of features, that are explicitly envisioned as being part of the disclosure. The following non-limiting Embodiments contain elements that are modular and can be combined with each other in any number, order, or combination to form a new non-limiting Embodiment, which can itself be further combined with other non-limiting Embodiments.

Embodiment 1. A computational device configured for determination of exposure to airborne particulate matter, the computational device comprising: circuitry configured to capture an image of a pollution detection article, wherein the image includes imagery of a discoloration reference of the pollution detection article and imagery of a polymer of the pollution detection article, wherein the polymer is configured to adsorb airborne particulates thereon to cause the polymer to become a discolored polymer; and circuitry configured to compare the discoloration reference to the discolored polymer for an optical comparison, wherein the optical comparison enables determination of whether the pollution detection article has airborne particulate matter exposure.

Embodiment 2. The computational device of any other Embodiment, wherein the discoloration reference optically corresponds to the discolored polymer, such that the imagery of the discoloration reference at least partially matches the imagery of the discolored polymer for determination of whether the pollution detection article has airborne particulate matter exposure.

Embodiment 3. The computational device of any other Embodiment, further comprising circuitry configured to determine whether the pollution detection article has airborne particulate matter exposure based on the optical comparison.

Embodiment 4. The computational device of any other Embodiment, wherein the pollution detection article comprises a plurality of discoloration references along a gradient and each discoloration reference corresponds to a degree of discoloration of the discolored polymer.

Embodiment 5. The computational device of any other Embodiment, further comprising circuitry configured to determine a level of airborne particulate matter exposure of the pollution detection article based on the optical comparison.

Embodiment 6. The computational device of any other Embodiment, further comprising circuitry configured to display, via a user interface, a recommendation for an action and/or a product based on a level of airborne particulate matter exposure of the pollution detection article as determined based on the optical comparison.

Embodiment 7. The computational device of any other Embodiment, wherein circuitry of the computational device is configured for image recognition detection of the discoloration reference and the discolored polymer based on an arrangement of the pollution detection article.

Embodiment 8. The computational device of any other Embodiment, wherein the arrangement includes a position of the discoloration reference relative to a position of the discolored polymer, or is predefined based on a layout of the discoloration reference and the discolored polymer on the pollution detection article.

Embodiment 9. The computational device of any other Embodiment, wherein the discoloration reference comprises an aperture thereon, such that a portion of a surface positioned underneath the aperture appears adjacent to the discoloration reference for the optical comparison between the discoloration reference and the discolored polymer.

Embodiment 10. A computational device configured for measurement of exposure to airborne particulate matter, the computational device comprising: circuitry configured to capture an image of a pollution detection article, wherein the image includes imagery of a plurality of discoloration references along a gradient and imagery of a polymer of the pollution detection article, wherein the polymer is configured to adsorb airborne particulates thereon to cause the polymer to become a discolored polymer; and circuitry configured to compare the plurality of discoloration references to the discolored polymer for an optical comparison, wherein the optical comparison enables measurement of exposure of the pollution detection article to airborne particulate matter.

Embodiment 11. The computational device of any other Embodiment, wherein each discoloration reference corresponds to a level of exposure to airborne particulate matter that is based at least in part on an airborne concentration of particulate matter in an environment.

Embodiment 12. The computational device of any other Embodiment, wherein the optical comparison comprises: computing, based on imagery of the image, a degree of discoloration of the discolored polymer; and computing a degree of discoloration of the plurality of discoloration references that is associated with the degree of discoloration of the discolored polymer to enable measurement of exposure of the pollution detection article to airborne particulate matter.

Embodiment 13. The computational device of any other Embodiment, wherein the optical comparison comprises: computing, based on imagery of the image, a plurality of degrees of discoloration of the plurality of discoloration references and computing a standard curve thereof configured for the computing the degree of discoloration of the plurality of discoloration references.

Embodiment 14. The computational device of any other Embodiment, further comprising circuitry configured to display, via a user interface, a recommendation for an action and/or a product based on a level of airborne particulate matter exposure of the pollution detection article as determined based on the optical comparison.

Embodiment 15. The computational device of any other Embodiment, wherein the recommendation is further based on a historical level of airborne particulate matter exposure of the pollution detection article and/or a historical level of airborne particulate matter exposure of an individual.

While illustrative embodiments have been illustrated and described, it will be appreciated that various changes can be made therein without departing from the spirit and scope of the disclosure.

The embodiments of the invention in which an exclusive property or privilege is claimed are defined as follows:

1. A computational device configured for determination of exposure to airborne particulate matter, the computational device comprising:
circuitry configured to capture an image of a pollution detection article, wherein the image includes imagery of a discoloration reference of the pollution detection article and imagery of a polymer of the pollution detection article, wherein the polymer is configured to adsorb airborne particulates thereon to cause the polymer to become a discolored polymer; and
circuitry configured to compare the discoloration reference to the discolored polymer for an optical comparison, wherein the optical comparison enables determination of whether the pollution detection article has airborne particulate matter exposure.

2. The computational device of claim 1, wherein the discoloration reference optically corresponds to the discolored polymer, such that the imagery of the discoloration reference at least partially matches the imagery of the discolored polymer for determination of whether the pollution detection article has airborne particulate matter exposure.

3. The computational device of claim 1, further comprising circuitry configured to determine whether the pollution detection article has airborne particulate matter exposure based on the optical comparison.

4. The computational device of claim 1, wherein the pollution detection article comprises a plurality of discoloration references along a gradient and each discoloration reference corresponds to a degree of discoloration of the discolored polymer.

5. The computational device of claim 1, further comprising circuitry configured to determine a level of airborne particulate matter exposure of the pollution detection article based on the optical comparison.

6. The computational device of claim 1, further comprising circuitry configured to display, via a user interface, a recommendation for an action and/or a product based on a level of airborne particulate matter exposure of the pollution detection article as determined based on the optical comparison.

7. The computational device of claim 1, wherein circuitry of the computational device is configured for image recognition detection of the discoloration reference and the discolored polymer based on an arrangement of the pollution detection article.

8. The computational device of claim 7, wherein the arrangement includes a position of the discoloration reference relative to a position of the discolored polymer, or is predefined based on a layout of the discoloration reference and the discolored polymer on the pollution detection article.

9. The computational device of claim 7, wherein the discoloration reference comprises an aperture thereon, such that a portion of a surface positioned underneath the aperture appears adjacent to the discoloration reference for the optical comparison between the discoloration reference and the discolored polymer.

10. A computational device configured for measurement of exposure to airborne particulate matter, the computational device comprising:
circuitry configured to capture an image of a pollution detection article, wherein the image includes imagery of a plurality of discoloration references along a gradient and imagery of a polymer of the pollution detection article, wherein the polymer is configured to adsorb airborne particulates thereon to cause the polymer to become a discolored polymer; and
circuitry configured to compare the plurality of discoloration references to the discolored polymer for an optical comparison, wherein the optical comparison enables measurement of exposure of the pollution detection article to airborne particulate matter.

11. The computational device of claim 10, wherein each discoloration reference corresponds to a level of exposure to airborne particulate matter that is based at least in part on an airborne concentration of particulate matter in an environment.

12. The computational device of claim 10, wherein the optical comparison comprises:
computing, based on imagery of the image, a degree of discoloration of the discolored polymer; and
computing a degree of discoloration of the plurality of discoloration references that is associated with the degree of discoloration of the discolored polymer to enable measurement of exposure of the pollution detection article to airborne particulate matter.

13. The computational device of claim 12, wherein the optical comparison comprises:
computing, based on imagery of the image, a plurality of degrees of discoloration of the plurality of discoloration references and computing a standard curve thereof configured for the computing the degree of discoloration of the plurality of discoloration references.

14. The computational device of claim 10, further comprising circuitry configured to display, via a user interface, a recommendation for an action and/or a product based on a level of airborne particulate matter exposure of the pollution detection article as determined based on the optical comparison.

15. The computational device of claim 14, wherein the recommendation is further based on a historical level of airborne particulate matter exposure of the pollution detection article and/or a historical level of airborne particulate matter exposure of an individual.
